(19) United States
(12) Patent Application Publication
(10) Pub. No.: US 2002/0117888 A1
(43) Pub. Date: Aug. 29, 2002

(54) Wheel for a motor vehicle made from a magnesium-containing alloy

(76) Inventor: Joerg Wurft, Schiltach (DE)

Correspondence Address: Law Offices of Dick and Harris, Suite 3800, 181 West Madison Street, Chicago, IL, 60602, US

(21) Appl. No.: 10/086,229

(22) Filed: Feb. 27, 2002

(30) Foreign Application Priority Data
Feb. 27, 2001 (DE) 101 09 386.1

(51) Int. Cl. B60B 25/00

(52) U.S. Cl. 301/35.632

(57) ABSTRACT

A wheel (1) for a motor vehicle, made from a magnesium-containing alloy, with a wheel key unit which has a central area (2) in which attachment borings (10) for attachment bolts as well as a hub boring (20) are positioned, and which has a rear, ring-shaped placement area (30) for the mounting onto a brake disk, whereby the attachment borings (10), the hub boring (20), and the placement area (30) are provided with spacer units (110, 120, 130) made from an aluminum-containing alloy. By this means, contact corrosion on the steel-containing attachment- and motor vehicle parts is prevented.

### BACKGROUND OF THE DISCLOSURE

1. Field of the Invention

The invention relates to a wheel for a motor vehicle made from a magnesium-containing alloy in accordance with the introductory portion of claim 1.

2. Background Art

Light-metal wheels for motor vehicles are gaining increasing popularity since, in addition to the increased overall esthetic appearance of the motor vehicle, they also offer technical advantages which derive from the reduced weight in comparison with conventional wheels. In order to achieve a greater reduction of weight, light-metal wheels are increasingly also made from magnesium-containing alloys.

In the simplest case, the wheel is manufactured as a single part and consequently consists completely of a magnesium-containing alloy. For higher requirements, particularly for use in racing cars or on vehicles of the highest class, multi-part wheels, in which certain sections, corresponding to the mechanical requirements, consist of different alloys, are also increasingly to be found. The invention described in the following consequently also includes such wheels as those in which the wheel key units, or at least their central areas, consist of a magnesium-containing alloy.

Although such types of wheels have best proven their value because of their low weight, the problem of contact corrosion appears in actual practice, particularly in the everyday use of motor vehicles licensed for roads. This involves, on the one hand, the placement area of the wheel on the brake disk which, at least at the present time, is still predominantly manufactured from steel. On the other hand, steel screws are additionally used for the attachment of the wheel so that contact corrosion appears, particularly in the placement area of the screw head. This is particularly undesirable there, since it additionally permanently affects the optical appearance in a negative manner. Particular value is placed precisely on this point in the purchase of such types of wheels, however.

The task which formed the basis for the invention was therefore the problem of further developing a wheel of the type stated above in such a manner that it no longer has the disadvantages described. In particular, the problem of the contact corrosion should be reliably solved without impairing the characteristics of the wheel as such and the handling of the same, particularly during the mounting.

### SUMMARY OF THE INVENTION

This problem is solved by means of a wheel with the characteristics of claim 1.

Advantageous forms of implementation of the invention are stated by the characteristics of the sub-claims.

The invention is based on the idea of providing spacer units in the areas endangered by corrosion, which units reliably prevent a direct contact between the section of magnesium-containing alloy under discussion and the component of steel: thus, the attachment screws, the hub, and the brake disk. The spacer units are consequently attached in the area of the attachment borings, the hub boring, and the placement surface for the brake disk, so that a direct contact is reliably prevented.

The spacer units are manufactured from an aluminum-containing alloy. These alloys are particularly suitable for this purpose since, because of their low specific weight, they only increase the overall weight of the wheel to a slight degree and are, in addition, resistant to corrosion. By means of these spacer units, it is managed, in a simple and reliable way and manner, to end the problem of the contact corrosion between the magnesium-containing components of the wheel and the steel-containing components, such as the attachment screws, the wheel placement in the hub area, and the brake disk.

The spacer units can, depending on the specific requirement and the specific course of the contour in the actual contact area, hereby be designed in a manner that is as open as possible.

It is preferable to provide a spacing disk on the brake disk in the area of the placement surface of the wheel. This is easy to manufacture and guarantees a placement of the wheel against the area of the brake disk that is secure and provided over a full surface.

A spacing tube which penetrates the hub boring in the axial direction, at least partially, is preferably provided in the area of the hub boring. The axial extension is selected in such a manner that a secure centering of the placement of the wheel is guaranteed.

The spacing disk and the spacing tube are, preferably, designed as a single-part, flange-like component. This simplifies the application of the spacer unit in the central area of the wheel, since both the hub area as well as the placement area on the brake disk can be covered by a single component.

Spacing liners which penetrate the attachment borings in the axial direction are preferably used in the area of the attachment borings. The spacing liners have, on the external side of the wheel, a funnel-shaped axial section with a spherical placement area for the head of the wheel screw. It is thereby ensured that the head of the wheel screw also does not enter into direct contact with the wheel.

It is advantageous to fix the spacing liners into the attachment borings in an unlosable manner. It has proven particularly advantageous, from the viewpoint of manufacturing technology, to press-fit the spacing liners into the attachment borings.

Alternatively or in addition to this, individual or all spacing liners can be connected with the spacing disk, so that an unlosable connection of the spacer unit can be achieved, particularly in the case of the single-part design of the spacing disk and spacing liner.

One variant provides for guiding the spacing liners to the wheel internal side through corresponding borings which are provided on the spacing disk, and of connecting them with the spacing disk on the internal side of the wheel.

One particularly simple possibility for this consists of providing the spacing liners with flange edges, which are rimmed radially externally after placing the spacing disk on. An interlocking connection between the spacing liners and the spacing disk, which makes a secure and unlosable attachment of the spacer unit on the wheel possible, is consequently brought about.

It is self-evident that the penetrating borings should not, after the bordering of the flange edge, project beyond the spacing disk in the axial direction, so that a full-surfaced placement between the wheel and spacing disk and the corresponding brake disk area is guaranteed. For this purpose, a shoulder, which is dimensioned in such a manner that it can completely accommodate the flange edge, is provided in the area of the penetrating borings.

### BRIEF DESCRIPTION OF THE DRAWINGS

The invention will now be illustrated in the following by means of the example of implementation schematically depicted in the single diagram. This depicts the following:

FIG. 1: Cut-out section of a wheel with spacer units in an axial cross-section.

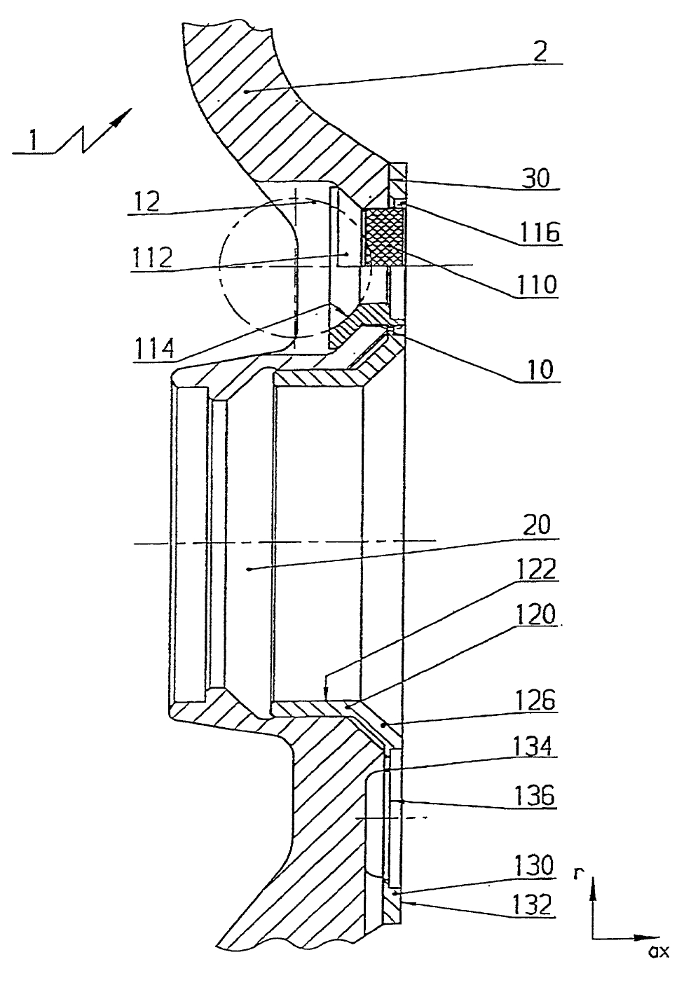

### DETAILED DESCRIPTION OF THE DRAWINGS

While this invention is susceptible of embodiment in many different forms, there are shown in the drawings and will be described herein one specific embodiment, with the understanding that the present disclosure is to be considered as an exemplification of the principles of the invention and is not intended to limit the invention to the embodiment illustrated.

A wheel (1) is manufactured from a magnesium-containing alloy, at least in the area of a wheel key unit or in a central area (2).

Attachment borings (10) for wheel attachment screws, which are not depicted in further detail here, are attached in the central area. The attachment borings (10) are, in this example of implementation, attached in the area with depressions (12), so that the attachment screws are sunk relative to the central area (12).

Furthermore, a hub boring (20), by means of which the wheel (1) can be placed onto a hub, which is not depicted here and which serves for the centering, is additionally present.

Finally, a placement area (30), with which the wheel (1) is connected on the rear side with a corresponding area of a brake disk, which is not depicted here, is provided.

In order to prevent contact corrosion between the wheel key unit (2), which consists of magnesium-containing alloy, and the stated components, such as the attachment screws, hub, and brake disk, which generally consist of steel, spacer units described in further detail in the following are provided. These are manufactured from an aluminum-containing alloy which is itself corrosion-resistant and, because of its low specific weight, does not contribute to any particular increase in the overall weight of the wheel (1).

The placement area (30) is covered by a spacing disk (130) which, in the example of implementation present here, is formed, in the radial direction (r) on the external circumference, to be snug with the placement area (30).

On the inside, the spacing disk (130) makes a transition, in the radial direction (r), into a transition section (126), which represents the connection with a spacing tube (120). The spacing tube (120) is guided, in the axial direction (ax), into the hub boring (20), and consequently represents a centering surface (122) for the hub, which is not depicted here.

The spacing disk (130) and the spacing tube (120) consequently form a one-part component which, in the present example of implementation, is designed as a single part. It is likewise possible to first manufacture the spacing disk (130) and the spacing tube (120) separately from one another, and to subsequently connect them into one construction unit. In every case, it is guaranteed that an automatic centering of the section representing the spacing disk (130) is carried out by inserting the section representing the spacing tube (120) into the hub boring (20). The component is inserted far enough into the hub boring (20) until the spacing disk (130) is applied tightly against the placement area (30) of the central area (2) over a complete surface. The contact surface towards the brake disk accordingly forms the frontal side of the spacing disk (130), which is formed as a placement surface (132).

Each of the attachment borings (10) is protected by a spacing liner (110), which completely penetrates the attachment boring (10) in the axial direction (ax). The spacing liner (110) has a funnel-shaped axial section (112), into which a spherical placement area (114) for the wheel screw is incorporated. In the axial direction (ax), the spacing liner (110) abuts with the funnel-shaped axial section (112) at the base of the depression (12).

Corresponding to the attachment borings (10), penetrating borings (134), into which the spacing liners (110) project inwardly in the axial direction (ax), are incorporated into the spacing disk (130).

One special feature of the example of implementation depicted now consists of the fact that the spacing liner (110) has a flange edge (116), by means of which the spacing disk (130) can be attached to the wheel key units (2) in an unlosable manner. For this purpose, a shoulder (136), which accommodates the flanged section of the flange edge (116), is attached to the spacing disk (130) in the area of the penetrating boring (134). In this way, it is guaranteed that the spacing liner (110) does not, in the axial direction (ax), project out over the frontal side serving as placement surface (133).

For an optimal preliminary assembly, it is advantageous if the spacing liners (110) are press-fitted into the attachment borings (10), that is to say, are designed as press-fitting liners. The flange-like component with the spacing disk (130) and the spacing tube (120) can then be placed onto the spacing liners (110) from the internal side of the wheel. The form-fitting connection is then produced by the bordering of the flange edges (116). A connection of the components serving as spacer units, namely, the spacing liners (110), spacing tube (120), and spacing disk (130), which is attached to the wheel (1) or the wheel key unit (2) in an unlosable manner, is thereby brought about. Upon mounting or dismounting the wheel (1), no differences from conventional light-metal wheels come about during the handling.

The foregoing description and drawings are merely to explain and illustrate the invention, and the invention is not limited thereto except insofar as the independent claims are so limited, as those skilled in the art with the present disclosure before them will be able to make modifications and variations therein without departing from the scope of the invention.

1. A wheel for a motor vehicle made from a magnesium-containing alloy, said wheel comprising:
a wheel key unit having a central area in which attachment borings for attachment bolts as well as a hub boring are positioned, said wheel key unit further having a rear, ring-shaped placement area for mounting to a brake disk,
wherein the attachment borings (10), the hub boring (20), and the placement area (30) are provided with spacer units (110, 120, 130) made from an aluminum-containing alloy.

2. The wheel of claim 1, wherein the spacer units (110, 120, 130) are attached, in an unlosable manner, to the wheel key unit or to the central area (2).

3. The wheel of claim 1, wherein a spacing disk (130) is provided on the placement area (30).

4. The wheel of claim 1, wherein a spacing tube (120), which at least partially penetrates the hub boring (20) in the axial direction (ax), is provided.

5. The wheel of claim 4, wherein the spacing tube (120) and the spacing disk (130) are formed as a single-part, preferably single-unit, flange-like component.

6. The wheel of claim 1, wherein spacing liners (110), which penetrate the attachment borings (10) in the axial direction (ax), are provided.

7. The wheel of claim 6, wherein the spacing liners (110) are designed as press-fitting liners and are press-fitted into the attachment borings (10).

8. The wheel of claim 6, wherein the spacing disk (130) has penetrating borings (134) through which the spacing liners (110) are guided and connected therewith.

9. The wheel of claim 8, wherein the spacing liners (110) have flange edges (116) for the forming of an interlocking connection with the spacing disk (130).
